(19) United States
(12) Patent Application Publication
(10) Pub. No.: US 2004/0065458 A1
(43) Pub. Date: Apr. 8, 2004

(54) Means and method for removing extraneous matter like ice/snow from an overhead line

(76) Inventor: Roger Hansen, Vestfold (NO)

Correspondence Address: WENDEROTH, LIND & PONACK, L.L.P., 2033 K STREET N. W., SUITE 800, WASHINGTON, DC, 20006-1021, US

(21) Appl. No.: 10/433,604

(22) PCT Filed: Dec. 6, 2001
(86) PCT No.: PCT/NO01/00484

(30) Foreign Application Priority Data
Dec. 7, 2000 (NO) 20006235

(51) Int. Cl. H02G 7/00

(52) U.S. Cl. 174/40 R

(57) ABSTRACT

In order to remove snow and ice from an overhead line (1), an operatively controllable electromechanical vibrator (5) is attached semi-permanently on a line section between pylons. Preferably, a snow/ice sensor (8) is arranged close by the vibrator (5), and the vibrator is preferably driven from a current transformer (4) mounted close by for inductive tapping of power from the line (1) itself. Preferably, the operation is controlled by means of a control unit (7).

The present invention relates in general to a means and a method for removing extraneous matter like ice or snow from an electric overhead line, i.e. a line suspended from one tower to the next.

Especially in connection with high voltage power lines in exposed winter mountain areas, forest areas and northern areas, snow and ice becoming attached to the lines, thereby weighing them down, may lead to power interruption and destructions that may imply very costly repairs. This may constitute a large problem for power companies and line companies. In some cases, large quantities of snow and ice will lead to a short-circuit in the network, and in other cases the power line pylons may be damaged.

Also overhead telecommunication lines and data lines may experience similar problems.

As far as is known, there exists today no useful automatic or remote-controlled system for detecting and removing extraneous material like snow and ice on overhead lines. The method used most often nowadays, is hitting the lines manually with insulated rods. In some cases regarding larger power lines, the air current from helicopter rotor blades are used to blow away the snow and ice masses, or a vibrator may be mounted on a hook below a helicopter, whereafter the helicopter flies in above the line and lifts the line, thereby to vibrate away the snow and ice load. This method can be very effective, but the problem is that when snow and ice pack onto the lines, this is due to weather conditions implying also that a helicopter cannot be used. Often, the power line may also carry a fibre optic cable, and in such a case the last mentioned method cannot be used even under good flying conditions, because of the damage risk for the fibre optic conductor from the helicopter hook.

However the patent literature exhibits some attempts regarding technical means for solving the above stated problem. From Norwegian laid-open publication no. 157 997 is known a device for removing snow and ice on electric overhead lines, using a bow means hanging on the line, the bow means to be pulled along the line by means of a rope, thereby to remove snow/ice. In other words, this is a rather manual method, which method does not differ much in sophistication from the above mentioned method of hitting the line with an insulated rod.

From Swedish patent publication no. 503 724 is known a “deicing means” for an ice-covered line, and the solution stated here, is also based on a device running along the line. The running device comprises roller members making the line flex between the rollers, and as a result, the ice cover will break up and fall off. Hence, this solution looks rather like the solution in the Norwegian laid-open publication, since a device must be pulled along the line.

From U.S. Pat. No. 5,411,121 (and Norwegian patent application no. 1996 3975) is known a more technical and automated deicing means for cables. This device includes a conducting wire pair wound helically along the cable to be deiced. In one end, the wires are connected to a pulsing device generating an electromagnetic pulse in the wires, and in the opposite end, the wires are connected together. When an electromagnetic pulse is emitted to the wires, a repulsive force will arise between the wires, which force will shake the wires and consequently crack the ice that may have attached itself to the cable. This device is also based on a detector device and appurtenant activating means for the ice removal system. In other words, there is provided a system that works automatically. The problem is only that practical tests show that the device in accordance with the US patent is not sufficiently effective to solve the task in a practical case.

Thus, there still exists a need of an apparatus that is useful in a practical case for automatic or remote-controlled removal of extraneous material like ice/snow from overhead lines. The goal of the present invention is to provide a means that solves this problem.

Hence, in accordance with the invention there is provided a means for removing extraneous material like ice and snow from an electric overhead line, for instance a high voltage line, and the means is characterized in that it comprises an operationally controllable electromagnetic vibrator attached semi-permanently on an overhead line section (i.e. line section between neighbour pylons), such as expressed also in the appended claim 1.

Preferable embodiments of the means in accordance with the invention appear from the appended dependent claims 2-21.

The invention also comprises a method for removing extraneous material like ice and snow from an electric overhead line, for instance a high voltage line, and the method is characterized in that an electromagnetic vibrator is attached semi-permanently on an overhead line section, and the vibrator is activated in accordance with control from a control unit, so that vibrations resulting in loosening of the extraneous material from the line, propagate along the line from the vibrator. The method is defined correspondingly in the appended claim 22.

Preferable embodiments of the method in accordance with the invention appear from the appended dependent method claims 23-25.

In the following, the invention shall be considered in more detail by discussing some exemplary embodiments, and in this connection it is referred to the appended drawings, in which

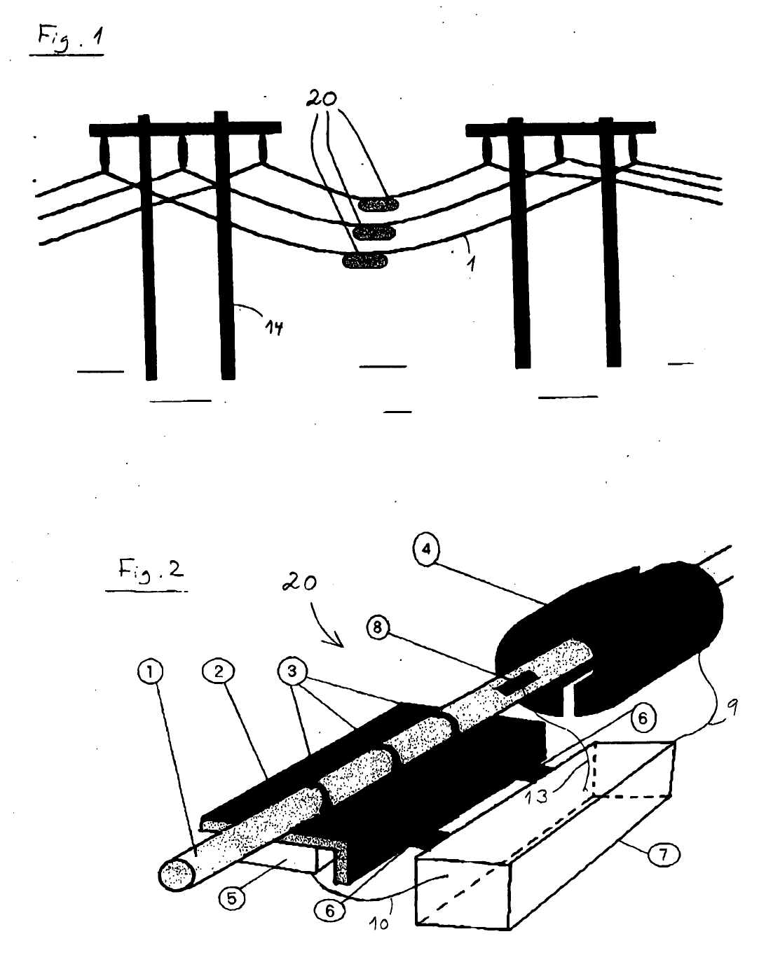

FIG. 1 shows a short section of a typical power line with three overhead phase leads,

FIG. 2 shows an embodiment of the means in accordance with the invention, attached to an overhead line,

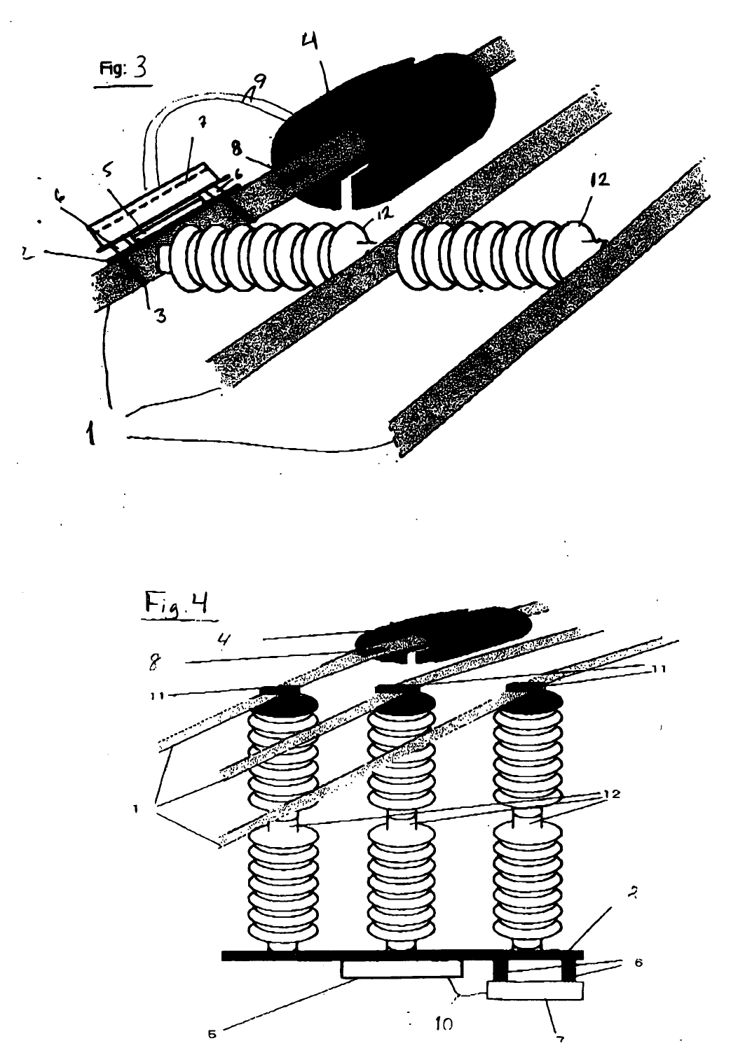

FIG. 3 shows an alternative embodiment of the means in accordance with the invention, adapted for use on three phase leads running in parallel,

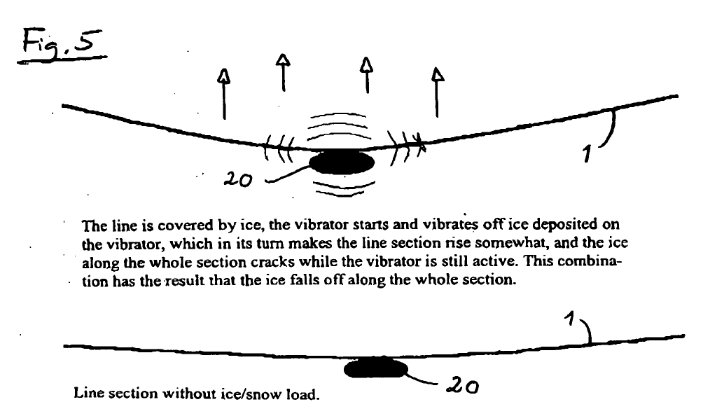

FIG. 4 shows an alternative embodiment, also this one for use on three phase leads running in parallel, and

FIG. 5 shows the effect of the means in accordance with the invention.

FIG. 1 shows the general mounting of the means in accordance with the invention, on overhead lines. From the figure appear pylons or towers 14 carrying high voltage lines 1, in the case shown, three such lines, and each one of the three lines is equipped with a means 20 for removing extraneous material on a section between two towers 14. The means 20 is attached approximately in the middle of the line section, in order to provide the same effect in both directions. However, the invention is not limited to such a location. Practical tests show that a means 20 will be effective also beyond the nearest tower or pylon 14 on both sides, with the result that it will often be unnecessary with a similar device on the next overhead section in both directions. This means that in exposed areas, it will be sufficient with one ice removal means 20 for every other overhead section.

FIG. 2 shows a means 20 in closer detail, and it appears that in this embodiment, means 20 comprises three substantial units, namely a vibrator 5, a control unit 7 and a current transformer 4. Additionally, an autonomous means 20 will need a sensor for sensing the presence of extraneous material, and a sensor is shown by reference numeral 8. The control unit 7 is operated by current received from the current transformer 4 via wires 9. The current transformer also supplies operating power for the vibrator 5, and the control unit 7 controls switching on/off of vibrator 5 on the basis of a signal received from sensor 8 through signal wire 13. The control unit 7 is inside a tight enclosure, and may comprise electronic circuitry in the form of a microprocessor with a timer function and possibly other functions, for instance in connection with remote-controlled switching on/off the vibrator via wireless (optical or RF) link from an external transmitter. This means that the control unit 7 will then also comprise a signal receiver of a similar type.

In the embodiment shown in FIG. 2, the vibrator 5 is mounted on a mounting bracket 2, and this mounting bracket is attached in its turn permanently, however removably, to line 1. The bracket 2 is attached fixedly and rigidly to line 1 by means of attachment details 3, in this case clamps. Control unit 7 is attached to mounting bracket 2 via vibration-absorbing suspension devices 6. The vibrator 5 itself is an off-the-shelf component, and can be supplied from several manufacturers, for instance the firm Wacker, USA, e.g. model Wacker 400W ER.

The sensor 8 shown here, may for example be a strain gauge of usual or custom type. Such a strain gauge 8 will sense strain in the line, which strain is in its turn a function of the weight of extraneous material on the line. Hence, the control unit 7 will, when strain above a certain threshold value is measured, interpret this measurement as presence of extraneous material/ice/snow in such a quantity that removal is necessary. Then, current will be connected to vibrator 5, which vibrator will provide shaking of the line.

Alternative sensor types may be sensors detecting weight or pressure directly, for instance in the form of a pressure-sensitive switch “clicking in” when it is exposed to a certain force, for instance a switch of make Crouzet, type 83 123 05. Or, sensors detecting thickness of snow or ice on the line, by optical (IR) measurement, for instance a sensor of make SunX, type LH-50.

The control unit 7 can be pre-programmed for maintaining vibrator operation during a predetermined time interval, or the vibrator can be switched off as a reaction to a change in the signal from sensor 8. One possible control algorithm may be to maintain vibration for a certain time after the moment when the sensor signal reaches a certain threshold value indicating a satisfactorily small amount of extraneous material on the line.

The reason behind the shock-absorbing suspension devices 6 for control unit 7, is that the strong vibrations from the vibrator against the mounting bracket 2, shall not be able to do damage on the components in the control unit 7. Also current transformer 4 may be attached by means of shock-absorbing suspension devices to reduce the possibilities of destructing the current transformer. Besides, the current transformer embodiment shown in FIG. 2, is particularly favourable. This current transformer 4 is constructed in two parts having half moon shaped cross section, so that the mounting onto high voltage line 1 can be made in a very simple manner.

The control unit 7 is encapsulated tightly in a housing constructed to withstand strong weather conditions.

FIG. 3 shows an embodiment in which three parallel-running phase leads 1 are influenced simultaneously by means of one single ice removal device. Many features in FIG. 3 are the same features as those shown in FIG. 2, for instance current transformer 4, sensor 8 and vibrator 5 on a mounting bracket 2 which is in its turn attached to lead 1 by means of clamps 3, but the control unit 7 is mounted somewhat differently to mounting bracket 2, however still with shock-absorbing suspension devices 6.

The special feature in this situation, are insulators 12 rigidly attached in between the three leads, for transferring shaking/vibrations from the lead on the far left, where vibrations are generated by vibrator 5. In this manner, vibration of three leads is obtained simultaneously.

Another variant of the same idea appears from FIG. 4, in which figure a mounting bracket 2 is placed differently than in the two previous cases. The mounting bracket, which also in this case has vibrator 5 mounted directly thereon, holds three insulators 12 rigidly, and the three insulators are attached rigidly in their opposite ends by means of clamps 11, to three leads 1. Hence, vibrations are transferred from vibrator 5 through the mounting bracket 2 and the insulators 12 to the three leads 1. Like in the previous cases, driving power comes from a current transformer 4 of the same type as mentioned previously, and a sensor 8 works together with control unit 7 in the same manner as previously explained. The control unit is also in this case attached to mounting bracket 2 in a shock-absorbing manner.

FIG. 5 shows the effect of an ice removal means in accordance with the invention. In the condition shown in the upper part of the drawing, line 1 hangs down due to the weight of ice/snow, and consequently vibration is started. Some of the ice/snow near the device 20 will start loosening, which in its turn has the effect that the line becomes somewhat lighter, and moves a little bit upwards. This effect helps in cracking the ice further on outwards, in cooperation with the ongoing vibration. An enhanced effect is obtained by the “geometrical” effect from straightening of the line.

In the lower part of the drawing appears the resulting situation, namely a normal overhead line with only a little sagging, without ice or snow load.

In areas known to give a large ice load on the line sections, it is possible to use, in a favourable embodiment of the invention, a double-action vibrator, i.e. the vibrator comprises two counter-working vibrator means, and when two such vibrator means are arranged in succession in a direction along the line, working in opposing phases, a special vibratory motion that has turned out to be very efficient, is created. Such a “linear” vibratory motion may result in breaking up and removing even hard blue ice, caused by supercooled rain.

The means in accordance with the invention for removing extraneous material does not need any special limitation as to the energy supplied to vibrator, control unit and sensor, because the energy is taken directly from the power line. In the exemplary embodiments already discussed, this takes place in an inductive fashion by means of a transformer device laid around the power line. In another embodiment adapted to powerlines not transferring high voltage energy, it is possible to use the current in the lines to drive the vibrator, the control unit and the sensors. Favourably, one may arrange a direct current outlet from two parallel-running phase leads adjacent to the means for removing ice/snow. In another embodiment, adapted for instance to telecommunication lines, current can be supplied separately for operating the vibrator, the control unit and the sensor, via the nearest pylon with power current.

Every time when the vibrator starts, the control unit may also activate a modem that transmits a signal to an operation central, which operation central then records which device has been active, i.e. in which position on the power line a vibrating action has been necessary. At the same time, knowledge is acquired regarding how much snow/ice has been attached to the line prior to activating the vibration device. Besides, the means in accordance with the invention can also be activated by means of radio signals, for instance on the basis of information from a max-dynamometer indicating snow/ice conditions on power lines.

In its most general form, the means in accordance with the invention comprises only one vibrator attached to an overhead line. Operating power can be provided via a separate wire, as previously mentioned, and a control unit for switching on/off may then be located far away from the vibrator, for instance at the end of the operating power wire. But the preferred embodiments comprise, as shown above, a control unit together with the vibrator.

In the drawings, embodiments are shown with only one sensor, but it may of course be of interest to use several sensors arranged in different positions on an overhead section between towers, in connection with an ice removal means.

The force, the amplitude and the frequency produced from the vibrator of the device, must be adapted to the topical type of line, and also to the topical type of tower/pylon. It goes without saying that it will be necessary with greater forces in connection with thick lines and long sections between towers, than in cases with line sections of smaller dimensions.

Hence, with the present invention, there is obtained a possibility for detecting, localizing and removing extraneous material like ice and snow on line networks. Thereby, the possibility of breakdowns caused by such extraneous material is also minimized.

1. A means for removing extraneous material like ice and snow from an electrical overhead line (1), for instance a high voltage line,
characterized in that it comprises an operatively controllable electromechanical vibrator (5) attached semi-permanently on an overhead line section.

2. The means of claim 1,
characterized in that it further comprises a system (4, 7) for tapping operating power from the electric current of the overhead line (1) itself.

3. The means of claim 2,
characterized in that said system for tapping operating power comprises a current transformer (4) mounted around the line (1) in close proximity to the vibrator (5).

4. The means of claim 3,
characterized in that the system further comprises a control unit (7) for controlling the moment of switching on and switching off vibrator (5) operation.

5. The means of claim 4,
characterized in that the control unit (7) is attached to a mounting bracket (2) which is in its turn attached to the line (1) by means of attachment means (3).

6. The means of claim 5,
characterized in that the mounting bracket (2) also works as an attachment for the vibrator (5), said attachment means (3) being adapted to provide rigid and direct contact between the mounting bracket (2) and the line (1), while the control unit (7) is attached to the mounting bracket (2) by means of vibration-dampening suspension d vices (6).

7. The means of claim 4,
characterized by at least one sensor (8) for detecting the presence or amount of extraneous material and delivering a signal to the control unit (7) via a signal wire.

8. The means of claim 7,
characterized in that said control unit (7) is adapted for interrogating and possibly energizing said sensor (8)

9. The means of claim 7,
characterized by at least one sensor (8) for detecting the thickness of extraneous material deposited on the line.

10. The means of claim 7,
characterized by at least one sensor (8) for sensing strain in the line (1), said strain being a function of the weight/load of the extraneous material on the line (1).

11. The means of claim 4,
characterized in that said control unit (7) comprises a microprocessor adapted for controlling disconnecting and connecting power from the current transformer (4) to the vibrator (5) in accordance with a measurement signal received from a sensor (8), a control signal received from the exterior, e.g. in a wireless manner from a manually operated and hand-carried transmitter on the ground nearby, or in accordance with pre-programming.

12. The means of claim 4,
characterized in that the vibrator (5) and the control unit (7) are attached to a mounting bracket (2) having insulators (12) mounted rigidly thereon, of which insulators one is attached rigidly to the line (1), and the remaining insulators are attached rigidly to respective parallel-running overhead lines (1), preferably phase leads belonging together, by means of clamp devices (11), said vibrator (5) being attached rigidly and directly to said mounting bracket (2), while the control unit (7) is attached by means of vibration-dampening suspension devices (6).

13. The means of claim 3,
characterized in that the system for tapping operating power comprises a direct current tap conductor connected between a stripped point on the line (1) and a correspondingly stripped point on a co-belonging phase lead (1) right next thereto.

14. The means of claim 13,
characterized in that the system further comprises at control unit (7) connected onto the current tap conductor, for controlling the moment of switching on and switching off vibrator (5) operation.

15. The means of claim 1,
characterized in that the vibrator (5) and an associated control unit (7) are adapted for receiving operating power via separate wiring from an external power source.

16. The means of claim 4,
characterized in that the control unit (7) is adapted for regulating instantaneous power supplied to the vibrator (5), for instance for adapting vibration amplitude or vibration speed to a detected amount of extraneous material on the line (1).

17. The means of claim 1, several lines (1) hanging in an overhead configuration in parallel together with said line (1),
characterized in that stiff insulators (12) are attached rigidly between said line (1) and a number of said several lines (1) closely adjacent to the vibrator (5), in such a manner that also said number of lines (1) enter a vibratory state when said vibrator (5) is in operation.

18. The means of claim 1,
characterized in that the vibrator (5) comprises two vibrator members working in parallel but in opposing phases.

19. The means of claim 1,
characterized in that the vibrator (5) is attached substantially in the middle of an overhead section, i.e. halfway between two pylons.

20. The means of claim 3,
characterized in that the current transformer (4) is shaped generally in two parts having half moon shaped cross sections.

21. The means of claim 4,
characterized in that the control unit (7) is equipped with a transmitter for wireless signal transmission to a receiver on ground level, for recording parameters like activating rate and e.g. average activating time, such signal transmission possibly being triggerable by interrogation from a hand-carried receiver on ground level.

22. A method for removing extraneous material like ice and snow from an electrical overhead line (1), for instance a high voltage line,
characterized in that
an electromechanical vibrator (5) is attached semi-permanently on an overhead line section, and
the vibrator (5) is activated in accordance with control from a control unit (7), so that vibrations resulting in loosening of the extraneous material from the line (1), propagate along the line (1) from the vibrator (5).

23. The method of claim 22,
characterized in that activation is carried out in accordance with evaluation in the control unit (7) of an incoming signal from at least one sensor (8) mounted on the line (1).

24. The method of claim 22,
characterized in that activation is carried out on the basis of an incoming wireless signal to the control unit (7) from a hand-carried transmitter on ground level.

25. The method of claim 22,
characterized in that operating power for the vibrator (5) is tapped from the line (1) itself by means of a current transformer (4) mounted therearound in immediate proximity to the vibrator (5).
